(19) United States
(12) Patent Application Publication
(10) Pub. No.: US 2022/0389744 A1
(43) Pub. Date: Dec. 8, 2022

(54) DOOR HINGE DEVICE OF VEHICLE

(71) Applicants: HYUNDAI MOTOR COMPANY, Seoul (KR); Kia Corporation, Seoul (KR)

(72) Inventor: Jaeseung LEE, Hwaseong-si, Gyeonggi-do (KR)

(73) Assignees: HYUNDAI MOTOR COMPANY, Seoul (KR); Kia Corporation, Seoul (KR)

(21) Appl. No.: 17/585,774

(22) Filed: Jan. 27, 2022

(30) Foreign Application Priority Data
Jun. 3, 2021 (KR) 10-2021-0072314

(51) Int. Cl. E05D 15/58; B60J 5/04; E05D 3/12; E05F 15/63

(52) U.S. Cl. CPC E05D 15/581; B60J 5/0479; E05D 3/127; E05F 15/63; E05D 2015/586; E05F 2015/631; E05Y 2900/531; E05Y 2201/422; E05Y 2201/41

(57) ABSTRACT

A door hinge apparatus of a vehicle may include a main bracket provided on one side of a vehicle body corresponding to an end portion of a door of the vehicle and having slide slots formed on upper and lower plates, respectively, a slide hinge bracket engaged to the slide slots to be slidable along the slide slots of the main bracket by a link mechanism, and a door hinge bracket Provided on the end portion of the door and pivotally connected to an external end portion of the slide hinge bracket through a hinge shaft.

### CROSS-REFERENCE TO RELATED APPLICATION

The present application claims priority to Korean Patent Application No. 10-2021-0072314 filed on Jun. 3, 2021, the entire contents of which is incorporated herein for all purposes by this reference.

### BACKGROUND OF THE INVENTION

### Field of the Invention

The present invention relates to a door hinge apparatus of a vehicle. More particularly, the present invention relates to a door hinge apparatus of a vehicle without a B-pillar that enables opening and closing operation of a rear door independently from a front door, by displacing the rear door rearward for the opening and closing operation to secure a rotation trajectory of the rear door to avoid interference with the front door.

### Description of Related Art

In general, a vehicle door is a door that separates the inside and outside of the vehicle. The vehicle door blocks external noise, rain, dust, wind, etc., and in case of a side surface collision, provides an important function of protecting the occupants by absorbing the impact together with the side structure to safely protect an occupant.

There are various types of vehicle doors, including special-purpose doors, but hinge-type swing doors are most commonly applied to passenger vehicles.

In general, a swing door refers to a door that opens toward the outside of the vehicle body around a hinge shaft provided between the door and the vehicle body through a hinge bracket, and has advantages of easy opening and closing and simple structure providing easy maintenance and repair.

On the other hand, some vehicles are applied with opposite swing doors, which have a large open feeling when the door is opened and is advantageous for occupants to get on or off the vehicle.

These opposite swing doors include a type without a B-pillar and a type with a B-pillar.

FIG. 1 is a side view of a vehicle applied with opposite swing doors according to an example of the related art, and FIG. 2 is a cross-sectional view exemplarily illustrating a portion in which a front door and a rear door meet each other in the vehicle of FIG. 1.

First, referring to FIG. 1 and FIG. 2, an example of opposite swing doors applied to a vehicle 100 without a B-pillar is illustrated. A front door 110 has a hinge shaft provided at the front end portion of the front door 110, and a rear door 120 has a hinge shaft provided at the rear end portion of the rear door 120.

A latch L for maintaining the locked state is provided on one side of the front door 110 or the rear door 120 in the opposite swing doors.

Furthermore, a sealing S for airtightness is provided between the rear end portion of the front door 110 and the front end portion of the rear door 120.

As described above, the opposite swing doors of the vehicle 100 without a B-pillar has good open feeling when the passengers get on/off or in leisure activities. However, there is a drawback that an opening/closing sequence may be preset such that the front door 110 must first be opened before or closed after opening or closing the rear door 120, due to overlapping interference of rotation trajectories of the front door 110 and the rear door 120 when opening and closing the front door 110 and the rear door 120.

Accordingly, since the opening/closing sequence of the front door 110 and the rear door 120 is preset, there is a problem in that the rear door 120 cannot be opened or closed alone.

FIG. 3 is a side view of a vehicle applied with opposite swing doors according to another example of the related art, and FIG. 4 is a cross-sectional view exemplarily illustrating a portion in which a front door and a rear door meet each other in the vehicle of FIG. 3.

Referring to FIG. 3 and FIG. 4, an example of opposite swing doors applied to a vehicle 200 with a B-pillar 230 is illustrated. In the instant case also, a front door 210 has a hinge shaft provided at the front end portion of the front door 2110, and a rear door 220 has a hinge shaft provided at the rear end portion of the rear door 220.

In the present opposite swing doors, a latch L for maintaining a locked state is provided between the B pillar 230 and each side of the front door 210 and the rear door 220.

Furthermore, a sealing S for airtightness is provided between the B-pillar 230 and the rear end portion of the front door 210 and the front end portion of the rear door 220 corresponding to the B-pillar 230.

Accordingly, in the opposite swing doors of the vehicle 200 with a B-pillar, it is advantageous that the front door 210 and the rear door 220 are configured to be independently opened and closed, and thus the operation sequence is not limited. However, the open feeling deteriorates when the passengers get on/off or in leisure activities, due to the application of the B-pillar 230.

Accordingly, depending on the presence or absence of the B-pillar, the opposite swing doors have a difference in open feeling, and a difference in opening and closing operations of the front door and the rear door.

Meanwhile, as described above, to solve the problem of the limited operation sequence of the front door 110 and the rear door 120 while maintaining the open feeling of the vehicle 100 without the B-pillar, there is an example of the related art that employs a gooseneck-type hinge device as a door hinge apparatus of the opposite swing doors. However, such a gooseneck-type hinge device requires a lot of free space in the vehicle body width direction due to the characteristic of its shape such that it is difficult to efficiently configure the vehicle body layout.

Accordingly, to apply the opposite swing doors to a vehicle without a B-pillar, a door hinge apparatus of implementing a new opening/closing structure is advantageous.

The information included in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a door hinge apparatus of a vehicle without a B-pillar that enables opening and closing operation of a rear door independently from a front door by displacing the rear door rearward for the opening and closing operation to secure a rotation trajectory of the rear door to avoid interference with the front door front door.

A door hinge apparatus of a vehicle according to various exemplary embodiments of the present invention includes, a main bracket provided on one side of a vehicle body corresponding to an end portion of a door of the vehicle and having slide slots formed on upper and lower plates, respectively, a slide hinge bracket engaged to the slide slots to be slidable along the slide slots of the main bracket by a link mechanism, and a door hinge bracket Provided on the end portion of the door and pivotally connected to an external end portion of the slide hinge bracket through a hinge shaft.

The end portion of the door may be a rear end portion of a rear door in the vehicle.

The main bracket may be provided on a side external panel corresponding to the rear end portion of the rear door such that the slide slots are disposed from a vehicle front internal side toward a vehicle rear external side thereof

The slide hinge bracket may be disposed between the upper plate and the lower plate of the main bracket along the slide slots, provided with two slide bars which are coupled to and slidable along the slide slots of the upper plate and the lower plate through a slider provided at end portions of the two slide bars.

The slider may be fitted with the two slide bars.

A door hinge apparatus of a vehicle according to various exemplary embodiments of the present invention may further include a driving unit coupled to the slide hinge bracket through the link mechanism including a plurality of links and configured to activate, through the plurality of links, the slide hinge bracket to move along the slide slots.

The driving unit may include, a motor provided on a mounting bracket formed on the main bracket, a motor gear provided on the mounting bracket and connected to a motor shaft of the motor, and a link gear provided on the mounting bracket and engaged with the motor gear. The plurality of links may be configured between a center portion of the link gear and one side of the slide hinge bracket and configured to transfer a linear force to the slide hinge bracket by use of a torque of the motor.

The mounting bracket may be formed to extend from a front end portion of the lower plate toward a vehicle front side and forms a gear installation portion.

The motor gear and the link gear may be engaged with each other and rotatably provided in the gear installation portion of the mounting bracket.

The motor gear and the link gear have a gear ratio to transfer the torque of the motor by deceleration.

The plurality of links may include, a first link having a first end portion fixed to a center portion of the link gear to rotate with the link gear, and a second link having a first end portion pivotally connected to a second end portion of the first link through a link pin and a second end portion pivotally connected to the slide hinge bracket.

According to various exemplary embodiments of the present invention, in a process of opening of the rear door, the rear end portion of the rear door is pushed toward the vehicle rear external side in advance, to secure the rotation trajectory of the rear door without interference with other component portions, and in the instant state, the opening and closing operation of the rear door alone is enabled.

Therefore, according to various exemplary embodiments of the present invention, in opposite swing doors of a vehicle without a B-pillar, while maintaining the merit of good open feeling when the passengers get on/off or in leisure activities, the door opening and closing sequence is not limited.

Furthermore, a door hinge apparatus of a vehicle according to an exemplary embodiment of the present invention is slimmer than a conventional gooseneck-type hinge device, and also has an advantage in vehicle body layout configuration because it does not require an extra free space for rear door operation.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a side view of a vehicle applied with opposite swing doors for instance of the related art.

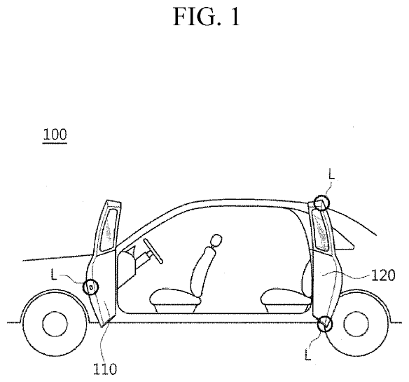

FIG. 2 is a cross-sectional view exemplarily illustrating a portion in which a front door and a rear door meet each other in the vehicle of FIG. 1.

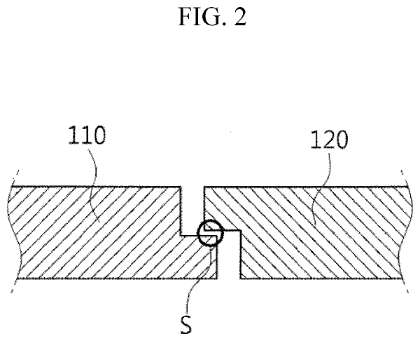

FIG. 3 is a side view of a vehicle applied with opposite swing doors according to another example of the related art.

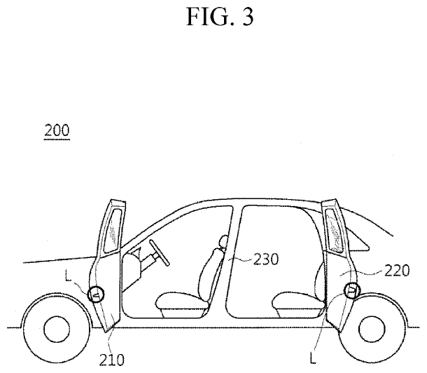

FIG. 4 is a cross-sectional view exemplarily illustrating a portion in which a front door and a rear door meet each other in the vehicle of FIG. 3.

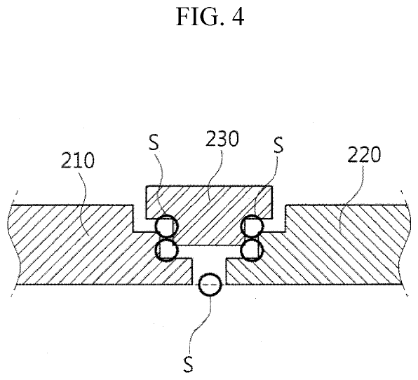

FIG. 5 is a perspective view of a door hinge apparatus of a vehicle according to various exemplary embodiments of the present invention, before operation.

FIG. 6 is another perspective view of a door hinge apparatus of a vehicle according to various exemplary embodiments of the present invention, before operation.

FIG. 7 is a perspective view of a door hinge apparatus of a vehicle according to various exemplary embodiments of the present invention, after operation.

FIG. 8 is a top plan view of a door hinge apparatus of a vehicle according to various exemplary embodiments of the present invention, before operation.

FIG. 9 is a top plan view of a door hinge apparatus of a vehicle according to various exemplary embodiments of the present invention, after operation.

FIG. 10 is a top plan view of a door hinge apparatus of a vehicle according to various exemplary embodiments of the present invention, when the door is opened.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Hereinafter, an exemplary embodiment will be described in detail with reference to the accompanying drawings.

The size and thickness of each element are arbitrarily shown in the drawings, but the present invention is not necessarily limited thereto, and in the drawings, the thickness of layers, films, panels, regions, etc., are exaggerated for clarity. Furthermore, the drawings and description are to be regarded as illustrative in nature and not restrictive.

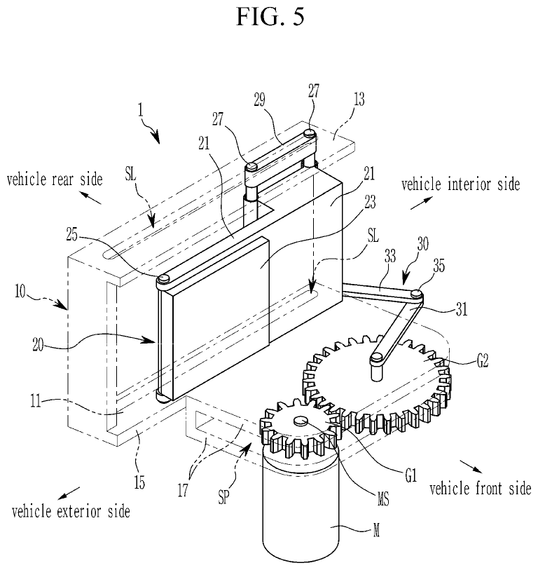

In describing various exemplary embodiments of the present invention, for convenience of the description, a lower left direction in FIG. 5 is referred to as a vehicle external side, an upper right direction in FIG. 5 is referred to as a vehicle interior side, an upper left direction in FIG. 5 is referred to as a vehicle rear side, and a lower right direction in FIG. 5 is referred to as a vehicle front side thereof. Furthermore, a door hinge apparatus of a vehicle according to various exemplary embodiments of the present invention may be provided at both rear doors of driver and passenger sides. For description, the following takes an example of a door hinge apparatus applied to the rear door of the passenger side thereof

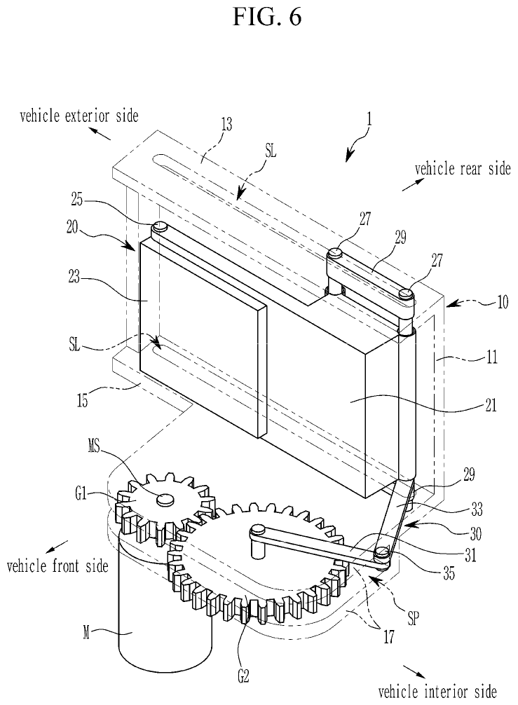

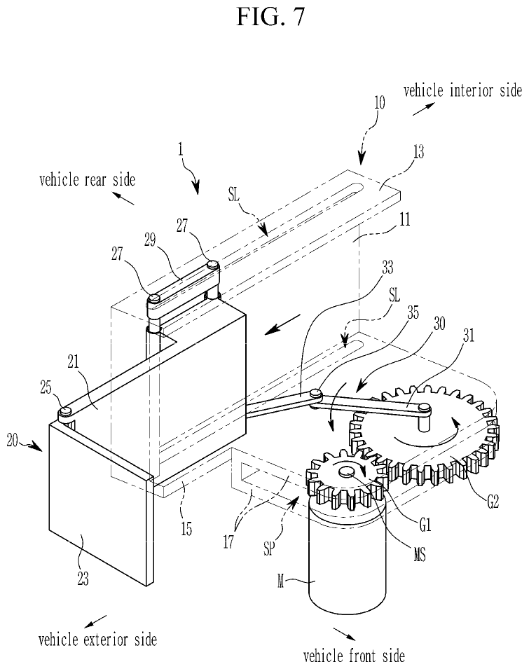

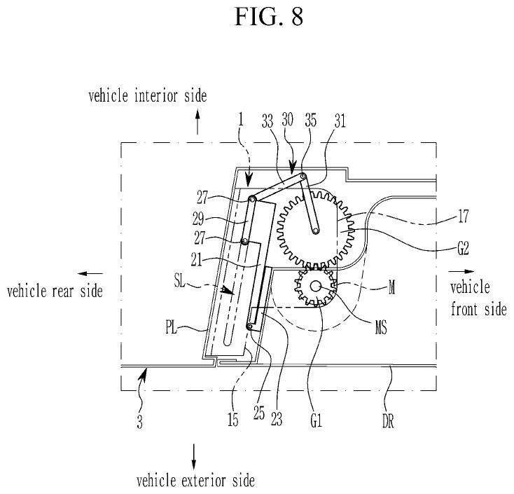

FIG. 5 is a perspective view of a door hinge apparatus of a vehicle according to various exemplary embodiments of the present invention, before operation, FIG. 6 is another perspective view of a door hinge apparatus of a vehicle according to various exemplary embodiments of the present invention, before operation, FIG. 7 is a perspective view of a door hinge apparatus of a vehicle according to various exemplary embodiments of the present invention, after operation, and FIG. 8 is a top plan view of a door hinge apparatus of a vehicle according to various exemplary embodiments of the present invention, before operation.

A door hinge apparatus of a vehicle according to various exemplary embodiments of the present invention may be applied to a rear door of a vehicle (e.g., a passenger vehicle) without a B-pillar. That is, the opening and closing operation of the rear door alone is enabled, by displacing the rear door rearward for the opening and closing operation to secure a rotation trajectory of the rear door to avoid interference with the front door front door.

Referring to FIG. 5, FIG. 6, FIG. 7, and FIG. 8, a door hinge apparatus 1 of a vehicle according to various exemplary embodiments of the present invention includes a main bracket 10, a hinge bracket unit 20 including a slide hinge bracket 21 and a door hinge bracket 23, and a driving unit 30.

First, the main bracket 10 includes a rear plate 11 fixed to a vehicle body 3, and also includes an upper plate 13 and a lower plate 15 that are formed toward the vehicle front side at an upper end portion and a lower end portion of the rear plate 11, respectively.

A slide slot SL of a straight section is formed on the upper plate 13 and the lower plate 15, respectively.

Furthermore, a mounting bracket 17 is formed on the lower plate 15. The mounting bracket 17 was formed to extend from a front end portion of the lower plate 15 toward the vehicle front side, and forms a gear installation portion SP including a space in the center portion in the vertical direction thereof

The main bracket 10 is provided on one side of the vehicle body 3 corresponding to a rear end portion of a rear door DR through the rear plate 11. At the instant time, the vehicle body 3 may be a side external panel PL corresponding to the rear end portion of the rear door DR. The main bracket 10 is provided on the vehicle body 3 such that the slide slots SL formed on the upper plate 13 and the lower plate 15 are disposed from a vehicle front internal side of the vehicle body 3 toward a vehicle rear external side thereof

The slide hinge bracket 21 and the door hinge bracket 23 in the hinge bracket unit 20 are interconnected through a hinge shaft 25, and they are provided to slide along the slide slot SL formed in the main bracket 10.

Here, the slide hinge bracket 21 includes two slide bars 27 and a slider 29.

That is, the slide hinge bracket 21 is disposed between the upper plate 13 and the lower plate 15 of the main bracket 10, along the slide slots SL.

The two slide bars 27 are formed in the shape of a circular bar and provided in a vertical direction on both sides of a rear plate of the slide hinge bracket 21.

The slider 29 is respectively provided at upper end portions and lower end portions of the two slide bars 27, and slidable along the slide slot SL of the upper plate 13 and the lower plate 15. At the instant time, an upper slider 29 is fitted with upper end portions of the two slide bars 27 as shown in the drawings, and a lower slider 29 is fitted with lower end portions of the two slide bars 27, symmetrically to the upper slider 29.

Furthermore, the door hinge bracket 23 is fixed to the rear end portion of the rear door DR, and is connected to an external end portion of the slide hinge bracket 21 through the hinge shaft 25.

The slide hinge bracket 21 may move the rear end portion of the rear door DR, along the slide slot SL of the main bracket 10, toward the vehicle rear external side of the vehicle body 3, to secure the rotation trajectory of the rear door DR. In the instant state, the rear door DR may be opened or closed through the door hinge bracket 23, independently from the front door.

Furthermore, the driving unit 30 includes a motor M, a motor gear G1, a link gear G2, first and second links 31 and 33.

The motor M is provided on the mounting bracket 17 of the main bracket 10. For example, the motor M is provided on a lower portion of the mounting bracket 17, which is formed on the lower plate 15 of the main bracket 10 and extends toward the vehicle front side thereof

At the present time, the motor M may be a step motor configured for controlling rotation speed and rotating direction thereof

Furthermore, the motor gear G1 is connected to a motor shaft MS of the motor M. At the instant time, the motor gear G1 is positioned in the gear installation portion SP of the mounting bracket 17 and connected to the motor shaft MS.

The link gear G2 is rotatably provided within the gear installation portion SP of the mounting bracket 17 and engaged with the motor gear G1.

Here, the motor gear G1 and the link gear G2 may have a gear ratio to transfer the torque of the motor M by deceleration.

That is, to transfer the torque of the motor M by deceleration, i.e., to achieve an increase torque, the motor gear G1 is formed with a smaller diameter than the link gear G2.

Furthermore, the first and second links 31 and 33 are configured between a center portion of the link gear G2 and one side of the slide hinge bracket 21 to transfer linear force to the slide hinge bracket 21 by use of the torque of the motor M.

A first end portion of the first link 31 is fixed to the center portion of the link gear G2 to rotate with the link gear G2.

A second end portion of the first link 31 is connected to a first end portion of the second link 33 through a link pin 35, and a second end portion of the second link 33 is connected to the slide bar 27 coupled with the slide hinge bracket 21.

Here, the second end portion of the second link 33 may be fitted with the lower end portion of the slide bar 27 disposed at the vehicle interior side of the slide hinge bracket 21.

When the torque of the motor M is transferred to the first link 31 through the motor gear G1 and the link gear G2, the first link 31 activates the second link 33 to push the slide hinge bracket 21 toward the vehicle external side to slide along the slide slot SL.

Hereinafter, an operation of a door hinge apparatus of a vehicle according to an exemplary embodiment of the present invention is described in detail with reference to FIG. 8 to FIG. 10.

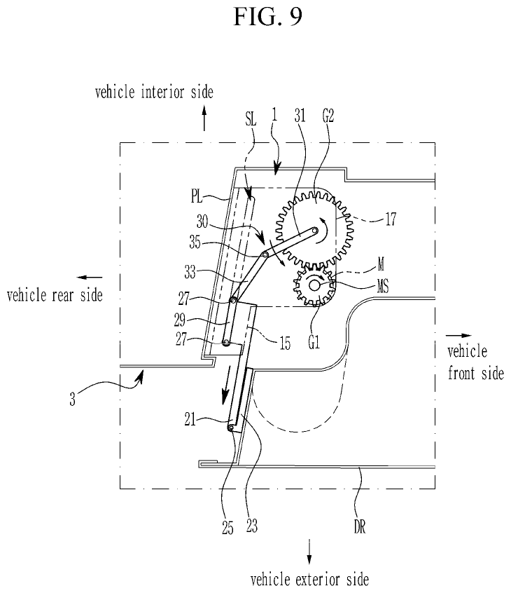

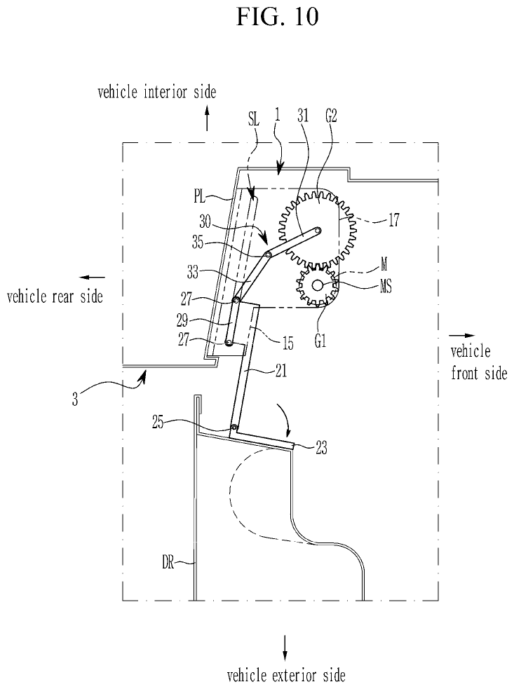

FIG. 9 is a top plan view of a door hinge apparatus of a vehicle according to various exemplary embodiments of the present invention, after operation, and FIG. 10 is a top plan view of a door hinge apparatus of a vehicle according to various exemplary embodiments of the present invention, when the door is opened.

First, referring to FIG. 8, the rear door DR is in a closed state.

At the present time, the slide hinge bracket 21 together with the rear end portion of the rear door DR is in a state having moved toward the vehicle front internal side of the vehicle body 3 along the slide slot SL of the main bracket 10, and the rear door DR remains at the closed state.

Referring to FIG. 9, to independently open the rear door DR, the motor M is first operated clockwise.

Accordingly, the motor gear G1 rotates the link gear G2 anticlockwise, and the first link 31 rotates with the link gear G2. Therefore, the slide hinge bracket 21 is pushed toward the vehicle external side of the vehicle body 3, through the second link 33.

Accordingly, the slide hinge bracket 21 moves toward the vehicle rear external side of the vehicle body 3 along the slide slot SL of the main bracket 10 by the pushing force of the second link 33, and the rear end portion of the rear door DR connected through the door hinge bracket 23 moves toward the vehicle rear external side of the vehicle body 3, to secure the rotation trajectory of the rear door DR.

Referring to FIG. 10, thereafter, when an occupant opens the rear door DR, the rear door DR is opened by rotating, together with the door hinge bracket 23, with respect to the slide hinge bracket 21 around the hinge shaft 25.

Meanwhile, the closing operation of the rear door DR is performed in an opposite manner to the opening operation such that the opening and closing operation of the rear door DR may be performed independently from the front door, and the operation is not described in further detail.

Therefore, a door hinge apparatus 1 of a vehicle according to various exemplary embodiments of the present invention may be applied to the vehicle body 3 and the rear end portion of the rear door DR among opposite swing doors of a vehicle without a B-pillar, facilitating the opening and closing operation of the rear door DR independently from the front door.

That is, the first and second links 31 and 33 operated by the motor M enables the slide hinge bracket 21 guided along the slide slot SL of the main bracket 10 to slide from the vehicle front internal side of the vehicle body 3 toward the vehicle rear external side thereof

Accordingly, in a process of opening of the rear door DR, the rear end portion of the rear door DR is pushed toward the vehicle rear external side in advance, to secure the rotation trajectory of the rear door DR without interference with other component portions, and in the instant state, the opening and closing operation of the rear door DR alone is enabled.

Accordingly, according to a door hinge apparatus 1 of a vehicle according to various exemplary embodiments of the present invention, in opposite swing doors of a vehicle without a B-pillar, while maintaining the merit of good open feeling when the passengers get on/off or in leisure activities, the rotation trajectory of the rear door DR may be secured when the rear door DR is opened and closed, and thereby the door opening and closing sequence is not limited.

Furthermore, a door hinge apparatus 1 of a vehicle according to an exemplary embodiment of the present invention is slimmer than a conventional gooseneck-type hinge device, and also has an advantage in vehicle body layout configuration because it does not require an extra free space for rear door operation.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A door hinge apparatus of a vehicle, the door hinge apparatus comprising:
a main bracket provided on one side of a vehicle body corresponding to an end portion of a door of the vehicle and having slide slots formed on upper and lower plates of the main bracket, respectively;
a slide hinge bracket engaged to the slide slots to be slidable along the slide slots of the main bracket by a link mechanism coupled to the slide hinge bracket; and
a door hinge bracket provided on the end portion of the door and pivotally connected to an end portion of the slide hinge bracket through a hinge shaft.

2. The door hinge apparatus of claim 1, wherein the end portion of the door is a rear end portion of a rear door in the vehicle.

3. The door hinge apparatus of claim 2, wherein the main bracket is provided on a side external panel corresponding to the rear end portion of the rear door and the slide slots are disposed from a vehicle front internal side toward a vehicle rear external side.

4. The door hinge apparatus of claim 1, wherein the slide hinge bracket is disposed between the upper plate and the lower plate of the main bracket along the slide slots, provided with two slide bars which are coupled to and slidable along the slide slots of the upper plate and the lower plate through a slider connecting end portions of the two slide bars.

5. The door hinge apparatus of claim 4, wherein the slider is fitted with the two slide bars.

6. The door hinge apparatus of claim 1, further including a driving unit coupled to the slide hinge bracket through the link mechanism including a plurality of links and configured to activate, through the plurality of links, the slide hinge bracket to move along the slide slots.

7. The door hinge apparatus of claim 6, wherein the driving unit includes:
a motor provided on a mounting bracket formed on the main bracket;
a motor gear provided on the mounting bracket and connected to a motor shaft of the motor; and
a link gear provided on the mounting bracket and engaged with the motor gear,
wherein the plurality of links is provided between a center portion of the link gear and one side of the slide hinge bracket and configured to transfer a linear force to the slide hinge bracket by use of a torque of the motor.

8. The door hinge apparatus of claim 7, wherein the mounting bracket is formed to extend from a front end portion of the lower plate toward a vehicle front side and forms a gear installation portion.

9. The door hinge apparatus of claim 8, wherein the motor gear and the link gear are engaged with each other and rotatably provided in the gear installation portion of the mounting bracket.

10. The door hinge apparatus of claim 7, wherein the motor gear and the link gear have a gear ratio to transfer the torque of the motor by deceleration.

11. The door hinge apparatus of claim 7, wherein the plurality of links includes:
a first link having a first end portion fixed to a center portion of the link gear to rotate with the link gear; and
a second link having a first end portion pivotally connected to a second end portion of the first link through a link pin and a second end portion pivotally connected to the slide hinge bracket.

12. A door hinge apparatus of a vehicle, the door hinge apparatus comprising:
a main bracket provided on one side of a vehicle body corresponding to an end portion of a door of the vehicle and having at least a slide slot formed on the main bracket, respectively;
a slide hinge bracket engaged to the at least a slide slot to be slidable along the at least a slide slot of the main bracket by a link mechanism coupled to the slide hinge bracket; and
a door hinge bracket provided on the end portion of the door and pivotally connected to an end portion of the slide hinge bracket.

13. The door hinge apparatus of claim 12,
wherein the main bracket includes an upper plate and a lower plate,
wherein the at least a slide slot includes a first slot formed in the upper plate and a second slot formed in the lower plate,
wherein the slide hinge bracket is slidably disposed between the upper plate and the lower plate, and
wherein the slide hinge bracket is provided with first and second slide bars which are coupled to and slidable along the first slide slot of the upper plate and the second slide slot of the lower plate through a slider connecting the first and second slide bars.

14. The door hinge apparatus of claim 12, further including a driving unit coupled to the slide hinge bracket through the link mechanism and configured to activate the slide hinge bracket to move along the first slide slot and the second slide slot.

15. The door hinge apparatus of claim 14, wherein the driving unit includes:
a motor provided on a mounting bracket formed on the main bracket;
a motor gear provided on the mounting bracket and connected to a motor shaft of the motor; and
a link gear provided on the mounting bracket and engaged with the motor gear,
wherein the link mechanism is provided between a center portion of the link gear and one side of the slide hinge bracket and configured to transfer a linear force to the slide hinge bracket by use of a torque of the motor.

16. The door hinge apparatus of claim 15, wherein the link mechanism includes:
a first link having a first end portion fixed to a center portion of the link gear to rotate with the link gear; and
a second link having a first end portion pivotally connected to a second end portion of the first link and a second end portion pivotally connected to the slide hinge bracket.
